(19) United States
(12) Patent Application Publication
(10) Pub. No.: US 2026/0222967 A1
(43) Pub. Date: Jul. 30, 2026

(54) NETWORK SELF-RECOVERY METHOD FOR WIRELESS NETWORK

(71) Applicant: HYBEE, INC., Seongnam-si, Gyeonggi-do (KR)

(72) Inventors: YONG HWAN LEE, Seoul (KR); JONG IL PARK, Seoul (KR)

(21) Appl. No.: 19/141,999

(22) PCT Filed: Nov. 14, 2023
(86) PCT No.: PCT/KR2023/018262

§ 371 Date: Jun. 20, 2025

(30) Foreign Application Priority Data
Dec. 20, 2022 (KR) 10-2022-0178915

(51) Int. Cl. H04W 40/34

(52) U.S. Cl. CPC H04W 40/34

(57) ABSTRACT

The present disclosure provides a method for self-healing in a multi-hop cluster-tree structured wireless communication network. The multi-hop cluster-tree structure includes the first router and the first tree structure in which the first router, operating as a cluster head, is connected to network devices in a parent-child device relationship. The method comprises: selecting, by the first router, a network device in the first tree structure as a role-switching device; performing a network self-healing process using the role-switching device; and handing over its router role to the role-switching device. The role-switching device is a network device can rejoin the network as a router in lieu of the first router when the first router is disconnected from its parent device.

### TECHNICAL FIELD

Embodiments of the inventive concept described herein relate to a method for self-healing in a wireless communication network, and more particularly, to a method for self-healing in a multi-hop cluster-tree structured wireless network.

### BACKGROUND

The Internet of Things (IOT) is a technology that enables the interconnection of numerous devices to exchange data and is essential for the implementation of various application services. In particular, wireless IoT networks (WINs), which provide IoT services via wireless communication, are widely used.

A wireless IoT network typically consists of a coordinator that manages the operation of the network and a plurality of network devices. These network devices possess communication and computational capabilities. However, when powered by batteries, the available power is limited, which in turn may restrict their communication range. To construct a large-scale wireless IoT network using low-power devices, it is desirable to connect the coordinator and the network devices in a multi-hop structure.

In a multi-hop network structure, some of the devices act as routers, which are capable of accommodating child devices, while the remaining devices serve as end devices, which cannot accommodate child devices.

In such a multi-hop network, device disconnection may occur due to signal interference, device failure, or power depletion. When such disconnections occur, it is crucial that the orphaned device, which has lost its connection to the network, can quickly rejoin the network to maintain connectivity among devices.

### DESCRIPTION OF THE INVENTION

### Technical Problem

The present invention provides a method for self-healing in a multi-hop cluster-tree structured wireless communication network that can significantly reduce the time required for network recovery by simplifying the self-healing process.

After the network is constructed, each router selects a parent candidate device that can allow network rejoining of itself and all its child devices. In the absence of such a device, the router selects one of its child devices as a role-switching device that can rejoin the network as a router in lieu of itself when it is disconnected from its parent device. This role-switching mechanism simplifies the network recovery process for the router and its child devices, thereby greatly reducing the time required for network self-healing.

According to various embodiments of the present invention, when a router becomes disconnected from the network (hereinafter referred to as the “orphaned router”) and no parent candidate device exists that can allow network rejoining of the router with a network depth equal to or less than its previous depth (hereinafter referred to as the “previous network depth”), a role-switching device that can rejoin the network with a network depth equal to or less than the orphaned router's previous network depth may rejoin the network in lieu of the orphaned router and takes charge of a router role of the orphaned router. As a result, the child devices of the orphaned router can recover their network connection all together, without individually performing the network self-healing process, thus significantly reducing the recovery time and complexity.

The technical problems addressed by the present invention are not limited to those mentioned above. Other technical challenges not explicitly described herein will be readily understood by those skilled in the art from the following detailed description of the invention.

### Means for Solving the Problem

A wireless network self-healing method according to an embodiment of the present a method for self-healing in a multi-hop cluster-tree structured wireless communication network, wherein the multi-hop cluster-tree structured network includes a first router and a first tree structure in which the first router, operating as a cluster head, is connected to network devices in a parent-child device relationship, the method comprising: a step in which the first router selects a network device in the first tree structure as a role-switching device; a step in which the first router performs a network self-healing process using the role-switching device; and a step in which the first router hands over its router role to the role-switching device; wherein the role-switching device is a network device that can rejoin the network as a router in lieu of the first router when the first router is disconnected from its parent device.

The method further includes a step in which the first router selects a parent candidate device among cluster heads excluding routers in the sub-tree of its parent device. The step in which the first router selects a network device in the first tree structure as a role-switching device is performed in the absence of parent candidate devices that can allow network rejoining of the first router and all of its child devices in the first tree structure all together.

The role-switching device is a network device in the first tree structure and has a parent candidate device that can accept network rejoining of the first router and all or some of child devices in the first tree structure as child devices of the role-switching device when the first router is disconnected from its parent device.

The step in which the first router selects a network device in the first tree structure as a role-switching device may include a step in which the first router orders its child devices to select a device for its parent candidate and devices for its child candidate, and a step in which the first router gets information on the selected parent candidate device and child candidate devices from its child devices.

The step in which the first router selects a network device in the first tree structure as a role-switching device may include, assuming that the maximum network depth is Lₘₐₓ, the network depth of the first router is Lᵣₒᵤₜₑᵣ, where 0<Lᵣₒᵤₜₑᵣ<Lₘₐₓ, the network depth of the parent candidate device of a network device is L′ᵣₛᵥ, where 0≤L′ᵣₛᵥ<Lₘₐₓ, and the first router has child routers, a step in which the first router selects a network device among its child devices as the role-switching device, which has a parent candidate device with a network depth less than that of the first router (i.e., L′ᵣₛᵥ<Lᵣₒᵤₜₑᵣ) and has at least a predetermined number of child candidate devices.

The step in which the first router selects a network device in the first tree structure as a role-switching device may include, when the first router has no child routers but has child end devices, a step in which the first router selects a network device as the role-switching device among its child devices, which has a parent candidate device with a network depth less than the maximum network depth minus one (i.e., L′ᵣₛᵥ<Lₘₐₓ−1) and has at least a predetermined number of child candidate devices.

The step in which the first router performs a network self-healing process using the role-switching device may include a step in which the first router orders the role-switching device to rejoin the network as a router by making network connection to the parent candidate device of the role-switching device; and a step in which, when the first router receives a signal indicating successful network rejoining of the role-switching device as a router, it orders its child devices which are not child candidate devices of the role-switching device to disconnect their network connection.

The step in which the first router performs a network self-healing process using the role-switching device may further include, a step in which the first router tries to receive a signal informing success or failure of network rejoining of the role-switching device as a router in a predetermined time interval; and a step in which, if the first router receives a signal informing failure of network rejoining of the role-switching device as a router or it receives no signal in the predetermined time interval, it selects child devices which can rejoin the network with itself together and orders its child devices which cannot rejoin the network with itself together to make disconnection from the network.

The step in which the first router selects child devices which can rejoin the network with itself together and orders its child devices which cannot rejoin the network with itself together to make disconnection from the network may include, assuming that the maximum network depth is Lₘₐₓ and the network depth of the parent candidate device of the first router is Lᵣₛᵥ, where 0≤Lᵣₛᵥ<Lₘₐₓ, a step in which, if the first router has a parent candidate device with a network depth less than the maximum network depth minus one (i.e., Lᵣₛᵥ<Lₘₐₓ−1) and has child routers in the first tree structure, it orders its child routers to individually rejoin the network by themselves and requests its parent candidate device for network rejoining with its child end devices.

The step in which the first router selects child devices which can rejoin the network with itself together and orders its child devices which cannot rejoin the network with itself together to make disconnection from the network may include, assuming that the maximum network depth is Lₘₐₓ and the network depth of the parent candidate device of the first router is Lᵣₛᵥ, where 0≤Lᵣₛᵥ<Lₘₐₓ,a step in which, if the first router has no parent candidate device with a network depth less than the maximum network depth minus one (i.e., Lᵣₛᵥ<Lₘₐₓ−1), it orders all of its child devices to individually rejoin the network by themselves and requests its parent candidate device for network rejoining by itself alone.

The step in which the first router hands over its router role to the role-switching device may include a step in which the first router receives a network address space allocated by the role-switching device; a step in which the first router transmits the role-switching device a role-switching command that includes information on resources for communication with the child candidate devices of the role-switching device; and a step in which the first router becomes as a child device of the role-switching device.

According to one embodiment, a wireless network self-healing method according to an embodiment of the present a method for self-healing in a multi-hop cluster-tree structured wireless communication network, wherein the multi-hop cluster-tree structured network includes a first router and a first tree structure in which the first router, operating as a cluster head, is connected to network devices in a parent-child device relationship, the method comprising: a step in which the first child device is selected as a role-switching device by the first router; a step in which the first child device performs a network self-healing process by receiving a network address space from its parent candidate device; and a step in which the first child device allocates a network address space to the first router and takes charge of a router role of the first router; wherein the first child device is a network device that can rejoin the network as a router in lieu of the first router when the first router is disconnected from its parent device.

The first child device is a network device that has a parent candidate device that can allow network rejoining of the first router and all or some of its child devices in the first tree structure when the first router is disconnected from its parent device.

The step in which the first child device is selected as a role-switching device by the first router may include a step in which the first child device receives a command from the first router to select a device for its parent candidate and devices for its child candidates; a step in which the first child device selects the parent candidate device and the child candidate devices; and a step in which the first child device transmits information on the selected parent candidate device and child candidate devices to the first router.

The step in which the first child device selects the parent candidate device and the child candidate devices may include a step in which the first child device transmits and receives signals to and from its neighboring network devices in the network; a step in which the first child device determines whether the neighboring network devices are a cluster head in the first tree structure based on the signals received from the neighboring network devices; and a step in which the first child device selects a cluster head which is not in the first tree structure and can accept network rejoining of the first child device as a router and has a link quality to and from the first child device, equal to or greater than a predetermined value, as its parent candidate device.

The step in which the first child device selects the parent candidate device and the child candidate devices may include a step in which the first child device transmits and receives signals to and from its neighboring network devices in the network; a step in which the first child device determines whether the neighboring network devices are a sibling device of the first child device based on the signals received from the neighboring network devices; and a step in which the first child device selects a cluster head which is a child device of the first router and has a link quality to and from the first child device equal to or greater than a predetermined value, as its child candidate device.

The step in which the first child device is selected as a role-switching device by the first router may further include, assuming that the maximum network depth is Lₘₐₓ, the network depth of the first router is Lᵣₒᵤₜₑᵣ, where 0<Lᵣₒᵤₜₑᵣ<Lₘₐₓ, the network depth of the parent candidate device of the first child device is L′ᵣₛᵥ, where 0≤L′ᵣₛᵥ<Lₘₐₓ, and the first router has child routers, a step in which the first child device is selected as a role-switching device by the first router if it has a parent candidate device with a network depth less than that of the first router (i.e., L′ᵣₛᵥ<Lᵣₒᵤₜₑᵣ) and has at least a predetermined number of child candidate devices.

The step in which the first child device is selected as a role-switching device by the first router may further include a step in which, the first child device is selected as the role-switching device by the first router provided that the first router does not have any child router but has at least one child end device, the first child device has a parent candidate device with a network depth less than the maximum network depth minus one (i.e., L′ᵣₛᵥ<Lₘₐₓ−1) and has at least a predetermined number of child candidate devices.

The step in which the first child device performs a network self-healing process may include a step in which the first child device receives a signal from the first router, that includes a command to initiate a network rejoining process to the parent candidate device of the first child device as a child router; a step in which the first child device requests its parent candidate device for network rejoining of the first child device; and a step in which the first child device transmits the first router a signal informing success or failure of network rejoining as a router.

The step in which the first child device transmits the first router a signal informing success or failure of network rejoining as a router may include a step in which, when the first child device is allocated a network address space for router role from its parent candidate device, the first child device transmits the first router a signal indicating successful network rejoining as a router.

The step in which the first child device allocates a network address space to the first router and takes charge of a router role of the first router may include a step in which the first child device allocates a network address space to the first router and its child candidate devices, which is a portion of the network address space allocated by its parent candidate device; a step in which the first child device receives a role-switching command from the first router, which includes information on resources for communication with the child candidate devices of the first child device; and a step in which the first child device takes charge of a router role of the first router.

The step in which the first child device takes charge of a router role of the first router may include a step in which the first child device operates as a parent device of the first router and accepts the child candidate devices as its child devices after successful communication with them using the information on resources for communication.

The present invention may include a non-transitory computer-readable recording medium storing a program for executing the wireless network self-healing method according to various embodiments of the present invention.

The present invention may include a program stored in a recording medium for execution by a computer to perform the wireless network self-healing method according to various embodiments of the present invention.

Further detailed embodiments are described in the accompanying specification and drawings.

### Advantages of the Invention

According to the present invention, after network construction, a first router selects a parent candidate device that can allow network rejoining of itself and all of its child devices. The first router also selects a role-switching device that can rejoin the network as a router in lieu of the first router when the first router is disconnected from its parent device in the absence of parent candidate devices. Accordingly, when the first router is disconnected from its parent device and has no parent candidate device, the role-switching device rejoin the network in lieu of the orphaned router, thereby simplifying the network recovery process for the orphaned router and its child devices, significantly reducing the time required for network recovery.

According to the present invention, the role-switching device can be selected as a network device capable of rejoining the network at a depth equal to or less than the previous network depth of the orphaned router, while accommodating the child devices of the orphaned router. By rejoining the network in lieu of the orphaned router and switching parent-child roles with the orphaned router, the role-switching device enables the orphaned router's child devices to recover the network connection without individually performing the recovery process, thereby greatly reducing recovery time and signaling overhead.

The effects of the embodiments of the present invention are not limited to the examples described above, and various other effects are included within this specification.

### BRIEF DESCRIPTION OF THE FIGURES

FIG. 1 is a drawing conceptually illustrating a cluster-tree-structured wireless network to which an embodiment of the present invention is applicable;

FIGS. 2A and 2B are conceptual drawings for comparing and explaining a wireless network self-healing method according to an embodiment of the present invention with the related art;

FIG. 3 is a flowchart illustrating a wireless network self-healing method according to an embodiment of the present invention;

FIGS. 4A and 4B are flowcharts illustrating a process of determining a role-switching device according to an embodiment of the present invention;

FIGS. 5A and 5B are flowcharts illustrating a process of recovering a network using a role-switching device according to an embodiment of the present invention; and FIGS. 6A and 6B are flowcharts illustrating a process of updating network addresses and switching roles between an orphaned router and a role-switching device in a wireless network self-healing method according to an embodiment of the present invention.

### DETAILED DESCRIPTION

The advantages and features of the present invention, as well as the methods for achieving them, will become clear with reference to the embodiments described in detail below along with the accompanying drawings. However, the present invention is not limited to the embodiments disclosed herein and may be implemented in various other forms. These embodiments are provided merely to fully disclose the invention and to completely inform those skilled in the art of the scope of the invention to which the present invention pertains. The invention is defined solely by the scope of the claims.

Throughout the specification, identical reference numerals denote the same components. Although terms such as “first” and “second” are used to describe various components, these components are not limited by these terms. These terms are used solely to distinguish one component from another. Therefore, the “first” component mentioned herein may also be the “second” component within the technical scope of the present invention.

Hereinafter, specific embodiments will be described with reference to the accompanying drawings.

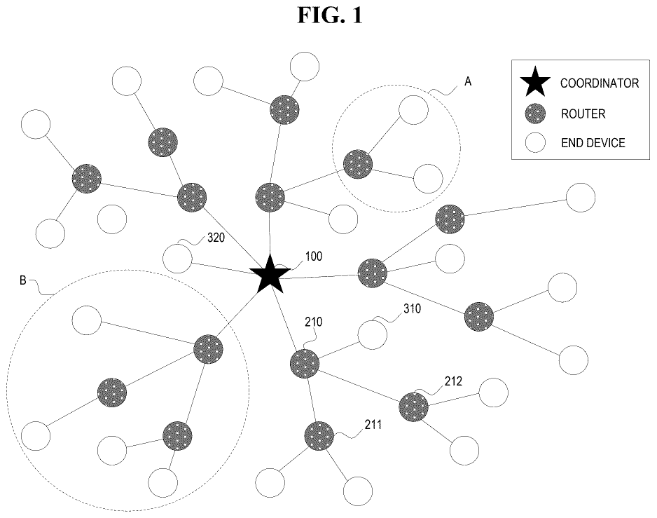

FIG. 1 is a drawing conceptually illustrating a cluster-tree structured multi-hop wireless network to which an embodiment of the present invention is applicable.

Referring to FIG. 1, a cluster-tree structured multi-hop wireless network according to an embodiment of the present invention includes a coordinator (100) that operates and manages the network, one or more routers (200) connected to the coordinator (100), and one or more end devices (300) connected to the coordinator (100), thereby forming a multi-hop cluster-tree structure.

For any pair of devices connected via a single hop, the device with a shorter hop to the coordinator (100) is defined as a parent device, and the device with a longer hop is defined as a child device. A child device may be defined as having a network depth that is one level greater than that of its parent device.

One parent device may be connected with at least one child device to form a cluster A. The coordinator (100) and routers (200) that can form clusters may also be referred to as Cluster Heads (CHs). The coordinator (100) and routers (200) establish parent-child relationships with routers (200) or end devices (300), thereby forming a multi-hop cluster-tree structured wireless network.

The coordinator (100) operates only as a parent device. A router (200) operates both as a parent device and as a child device, whereas an end device (300) operates only as a child device.

A router (200) may perform a child device role and a parent device role. For example, a first router (210) may be connected to the coordinator (100), operating as a child device, and may also be connected to a second router (211), a third router (212), and an end device (310), serving as their parent device. Each of the second router (211) and the third router (212) may also serve as a parent device to one or more end devices (not labeled).

Although FIG. 1 illustrates an example in which the second router (211) and the third router (212) serve as parent devices to end devices, the present invention is not limited thereto. For instance, if the maximum network depth exceeds three, the second router (211) and the third router (212) may each have child routers connected thereto, thereby serving as parent devices to the child routers.

Network devices such as routers (200) and end devices (300) generally have unique identifiers. However, to reduce signaling overhead, they are typically assigned network addresses upon joining the network, which are then used for communication.

In assigning such network addresses, the cluster-tree structured multi-hop wireless network is well-suited to a distributed address allocation method, which significantly reduces signaling overhead during network configuration. Furthermore, it enables tree routing based on the address structure, eliminating the need for additional route discovery or routing table management.

For example, all network devices may share information such as the maximum number of child devices (Cm), the maximum number of child routers (Rm), and the maximum network depth (Lm), as determined by the coordinator (100). Each cluster head, such as the first router (210), may receive a set of available addresses from its parent device (e.g., the coordinator (100)), corresponding to the maximum number of child devices (Cm). Among these, a subset of addresses corresponding to the maximum number of child routers (Rm) is allocated to its child routers (e.g., the second router (211) and the third router (212)), and the remaining addresses—i.e., those corresponding to the difference between Cm and Rm-may be assigned to its child end devices (e.g., the first end device (310)), which do not perform routing functions.

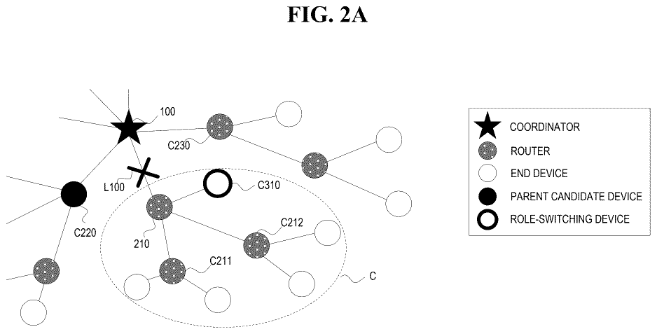

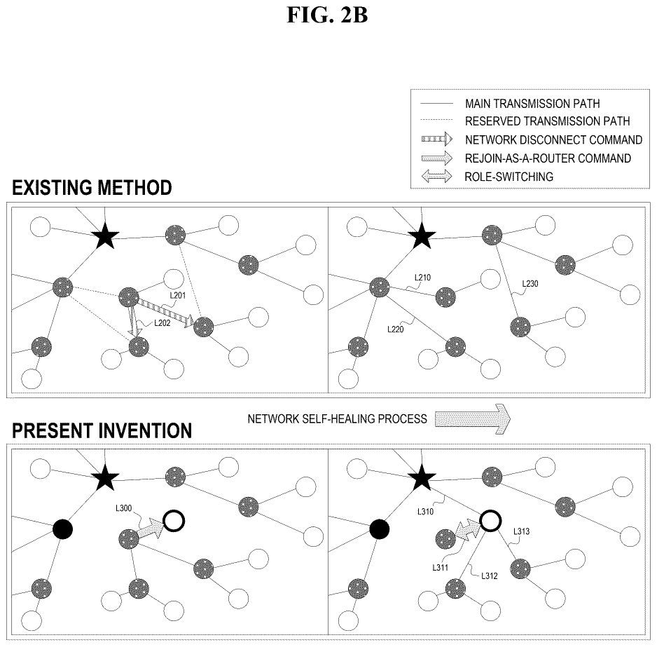

FIGS. 2A and 2B are drawings conceptually illustrating a wireless network self-healing method according to an embodiment of the present invention.

Referring to FIG. 2A, a wireless network self-healing method according to one embodiment of the present invention may be performed by a network device in a cluster-tree structure (C) comprising a plurality of clusters.

The cluster-tree structure (C) may include a first router (210), which serves as the top-level cluster head in the cluster-tree structure; second and third routers (C211, C212), which operate as child devices of the first router (210) and also as parent devices to at least one end device (300); and a first end device (C310), which operates as a child device of the first router (210).

In such a cluster-tree structure (C), in anticipation of or in the event that communication between the coordinator (100) and the first main router (210) becomes unavailable or unreliable (L100), the wireless network self-healing method according to one embodiment may be performed by the first router (210) or by any of its child devices.

In other words, in a given cluster-tree structure included in the wireless network, the method is designed to address situations in which communication between a cluster head and its parent device is unavailable or likely to become unavailable. The self-healing method according to the embodiment may thus be executed by the cluster head itself or by any of its child devices.

For example, the wireless network self-healing method according to an embodiment of the present invention may be performed by the first router (210) and a role-switching device (C310). The role-switching device (C310) may be a network device capable of accommodating the child devices belonging to the subtree structure (C) under the first router (210), by rejoining the coordinator (100) in lieu of the first router (210) and switching the parent-child relationship with the first router (210).

In the example shown in FIG. 2A, the role-switching device is illustrated as an end device (310) that is a child device of the first router (210). However, it is not limited thereto. In another example, the role-switching device may instead be one of the second router (211) or the third router (212), which are also child devices of the first router (210) and concurrently serve as parent devices to other devices.

FIG. 2B is a diagram provided to illustrate, in greater detail and in comparison with the prior art, the process by which the first router (210) performs a network self-healing process after determining that communication with the coordinator (100) is not available (L100), as shown in FIG. 2A.

In the network self-healing process according to the prior art, parent-child relationships among network devices are configured with a main transmission path and a reserved transmission path, and if a network device detects the main transmission path is disrupted, it continues operation by switching to the reserved transmission path.

For example, referring to FIGS. 2A and 2B, if the first router (210) attempts to switch to a reserved transmission path as its new main transmission path and finds no such path that allows rejoining the network along with all of its child devices belonging to its subtree (C), the first router (210) issues disconnection commands (L201, L202) to its child routers, namely the second and third routers (C211, C212).

In such a case, the first router (210) switches to a reserved transmission path that enables it to rejoin the network along with its child end device (310) (L210), while the second and third routers (C211, C212) respectively switch to their own reserved transmission paths (L220, L230).

In contrast, in the network recovery process according to an embodiment of the present invention, in the absence of parent candidate devices that can allow network rejoining of the first router (210) and all of its child devices in the subtree (C), the first router (210) selects a role-switching device (C310) from among its child devices that is capable of accommodating the subtree and orders the role-switching device to rejoin the network as a router.

Upon receiving a signal that includes a command to initiate a network rejoining process, the role-switching device (C310) requests its parent candidate device for network rejoining and takes charge of a router role of the first router (210). During this process, the role-switching device (C310) and the first router (210) may exchange all relevant data (L311), such as communication resources allocated to devices within the cluster-tree structure (C). As a result, the role-switching device (C310) operates as a parent device of the first router (210) and its child routers C211 and C212 (L312, L313).

Accordingly, the wireless network self-healing method according to the embodiment enables network recovery for the entire subtree of an orphaned router without requiring individual recovery by each child device, thereby significantly reducing both the recovery time and the complexity of the process.

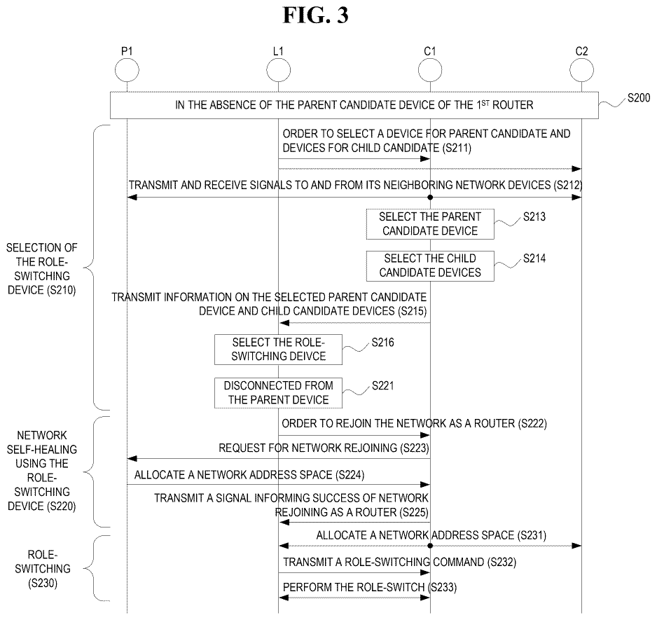

FIG. 3 is a flowchart illustrating a wireless network self-healing method according to an embodiment of the present invention.

Referring to FIG. 3, the wireless network self-healing method according to an embodiment may be performed by a router, one or more child devices of the router, and one or more parent candidate devices of the child devices. For example, the method may be performed by a first router (L1), which operates as a cluster head in a given cluster-tree structure, a first child device (C1) selected from among at least one child device (C1, C2) of the first router (L1), and a parent candidate device (P1) of the first child device (C1).

Here, the network depth of the first router (L1) and the parent candidate device (P1) of the first child device (C1) may vary depending on which parent device they form a parent-child relationship with. The first and second child devices (C1, C2) may each have a network depth one level greater than that of the first router (L1). The parent candidate device (P1) of the first child device (C1) may be a router capable of accommodating child devices and may correspond to any one of a plurality of unspecified cluster heads. Furthermore, each of the first and second child devices (C1, C2) may or may not have child devices of their own.

The wireless network self-healing method according to the embodiment may include a step in which the first router (L1), after network construction, determines its parent candidate devices and identifies that no parent candidate device is available that can allow network rejoining of the first router and all of its child devices in the first tree structure all together (Step S200), a step of selecting a role-switching device that can rejoin the network as a router in lieu of the first router (L1) (Step S210), a step in which the first router (L1), whose connection to its parent has been lost, performs a network self-healing process using the role-switching device (C1) (Step S220); and a step in which the role-switching device (C1) assigns network addresses to the first router (L1) and its child devices and hands over its router role to the role-switching device (Step S230).

In this context, Step S210 (selection of the role-switching device) will now be described in more detail.

If the first router (L1) determines that there is no parent candidate device with that can allow network rejoining of the first router and all of its child devices in the first tree structure all together, it orders its child devices to select a device for its parent candidate and devices for its child candidate (Step S211).

In FIG. 3, an example is illustrated in which the first router (L1) issues this instruction to the first child device (C1) from among multiple child devices (C1, C2). However, the present invention is not limited thereto, and the first router (L1) may issue the instruction to two or more or all of its child devices.

Network devices in the network-such as the first router (L1), the first and second child devices (C1, C2), and the parent candidate device (P1) of the first child device (C1)—may transmit a signal that includes information regarding the cluster networking environment and available network address space.

As shown in FIG. 3, when the parent candidate device (P1) of the first child device (C1) and/or the second child device (C2) transmits signals to the first child device (C1), the first child device (C1) may receive such signals and determine whether the parent candidate device (P1) has available network address space that can be allocated to it, and/or the transmission link condition between the first child device (C1) and the parent candidate device (P1) or second child device (C2) is above a predefined value (Step S212).

Depending on the embodiment, the cluster networking information included in the signal may include the network address of the transmitter device. The information on the available address space may be quantized as N bits representing the ratio of available address space to the total network address space, although this is not limiting.

Based on the received signals, the first child device (C1) may determine a parent candidate device (P1) (Step S213). For instance, the first child device (C1) may select a cluster head, other than routers in the subtree of the first router (L1), that meets the transmission link condition threshold and has available network address space, as its parent candidate device (P1).

Here, the predefined threshold value refers to a transmission link quality level that ensures reliable communication between the first child device (C1) and the candidate device, and may be preconfigured by an administrator, although not limited thereto.

Additionally, the first child device (C1) may determine child candidate devices based on the received signals (Step S214). For example, if the second child device (C2) meets the transmission link condition threshold, the first child device (C1) may select C2 as its child candidate device.

The first child device (C1) then transmits information on the selected parent candidate device (P1) and child candidate devices (C2) to the first router (L1) (Step S215). Then, the first router (L1) selects the first child device (C1) as its role-switching device (Step S216).

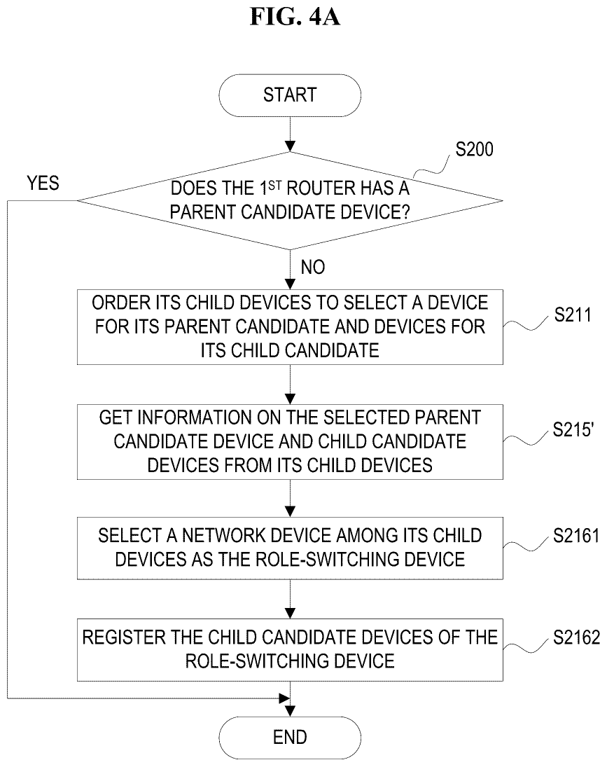

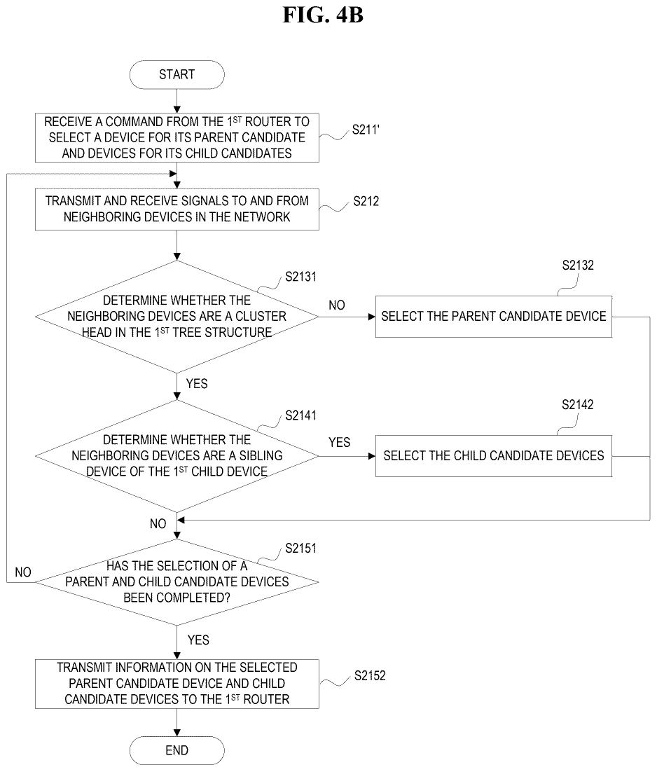

FIGS. 4A and 4B are flowcharts illustrating a process for selecting a role-switching device according to an embodiment of the present invention. FIGS. 4A and 4B provide detailed explanations of the role-switching device selection step (S210) of FIG. 3 from the perspectives of the first router (L1) and the first child device (C1), respectively.

Referring to FIG. 4A, when the first router (L1) determines that there is no parent candidate device that can allow network rejoining of the first router and all of its child devices in the first tree structure all together (step S200, NO), it may order its child devices to select a parent candidate device and child candidate devices (step S211).

Thereafter, the first router (L1) gets information on the selected parent candidate device and child candidate devices from its child devices (step S215′), and based on the information, selects the role-switching device (step S2161).

Upon receiving the information on the parent candidate device (P1) and child candidate devices (C2) from a child device (C1), the first router (L1) may evaluate whether the first child device (C1) can rejoin the network as a router and whether it is suitable as a role-switching device in consideration of the parent candidate device (P1) of the first child device (C1).

Further, when selecting the role-switching device, the first router (L1) may consider the network depth of the parent candidate device and the number of child candidate devices. In other words, when the first router (L1) gets information on parent candidate device and child candidate device from multiple child devices, it may register the multiple child devices as a set of role-switching candidate devices and select the role-switching device by considering the network depth of the parent candidate devices and the number of child candidate devices for each of the multiple child devices.

As a specific example, let the maximum network depth be denoted as Lₘₐₓ, the network depth of the first router (L1) as Lᵣₒᵤₜₑᵣ, the network depth of a parent candidate device of a child device of the first router (L1) as L′ᵣₛᵥ. When the first router (L1) has child routers, the first router (L1) may select a network device among its child devices as a role-switching device, which has a parent candidate device with a network depth less than that of the first router (i.e., L′ᵣₛᵥ<Lᵣₒᵤₜₑᵣ), and has at least a predetermined number of child candidate devices. In other words, when the first router (L1) includes one or more child routers, the role-switching device may be any one of the child routers or child end devices that satisfies the above conditions.

Here, the predetermined threshold value may be set in advance by a network administrator in consideration of factors such as the number of devices in the network, the number of routers included in the sub-tree, the maximum number of child devices, and the maximum number of child routers, but is not limited thereto.

If the first router (L1) has no child router but has child end devices, the first router (L1) may select a network device as the role-switching device among its child devices, which has a parent candidate device with a network depth less than the maximum network depth minus one (i.e., L′ᵣₛᵥ<Lₘₐₓ−1) and has at least a predetermined number of child candidate devices.

Next, the first router (L1) may register the child candidate device(s) of the role-switching device (step S2162).

If the first child device (C1) can rejoin the network as a router, the first router (L1) may select the first child device (C1) as its role-switching device and register the child candidate device (C2) of the first child device (C1). Accordingly, the first router (L1) may identify the sibling devices of the first child device (C1), i.e., the other child devices of the first router (L1) excluding the first child device (C1), which can communicate with the first child device (C1). For example, the second child device (C2) may be identified as such a sibling device.

If the first router (L1) gets information on the selected parent candidate device and child candidate devices from a plurality of child devices and more than one child device satisfies the conditions for being selected as a role-switching device, the step of selecting the role-switching device (step S2161) may further include a step of determining the highest-priority role-switching device.

For instance, the first router (L1) may select the highest-priority role-switching device based on the number of child candidate devices of each role-switching device. As a specific example, the first router (L1) may select, among the plurality of role-switching device candidates, the device having the largest number of child candidate devices as the highest-priority role-switching device.

Although in this embodiment, the first router (L1) is described as collecting multiple role-switching device candidates and selecting the highest-priority role-switching device, this is not limiting. In another example, the first router (L1) may get information on the selected parent candidate device and child candidate devices from multiple child devices and select any one of them as the role-switching device. In such a case, as previously described, the first router (L1) may select one role-switching device based on, for each child device, the network depth of its parent candidate device and the number of its child candidate devices.

Referring to FIG. 4B, when the first child device (C1) receives a command from the first router (L1) to select a parent candidate device and child candidate devices (step S211′), the first child device (C1) may transmit and receive signals with neighboring devices in the network (step S212).

Here, the neighboring devices refer to network devices in the network and include not only network devices belonging to the sub-tree of the first router (L1), but also the parent and sibling devices of the first router (L1).

Subsequently, the first child device (C1) may determine, based on information included in the received signal, whether the neighboring devices are a cluster head in the subtree of its parent device, i.e., the first router (L1) (step S2131).

If a neighboring device does not belong to the sub-tree of the first router (L1), and the first child device (C1) can rejoin the network as a router (step S2131: NO), the first child device (C1) may select the device (e.g., P1 in FIG. 3) as its parent candidate device (step S2132).

Additionally, the first child device (C1) may determine, based on the information included in the received signal, whether the neighboring devices are a sibling device (step S2141).

For example, if the signal is received from a cluster head belonging to the sub-tree of the first router (L1) (step S2131: YES), the first child device (C1) may determine whether the transmitter device is its sibling. Specifically, the first child device (C1) may compare its own network depth with that of the transmitter device to determine whether it is a sibling device. However, the method is not limited thereto.

Furthermore, the step of determining whether the neighboring device is a sibling device based on the information included in the signal (step S2141) may include determining whether the transmission link quality between the first child device (C1) and the sibling device satisfies a predetermined threshold.

Accordingly, if the neighboring device is a sibling of the first child device (C1), and the transmission link quality between the first child device (C1) and the neighboring device satisfies the predetermined threshold (step S2141: YES), the first child device (C1) may determine the neighboring device (e.g., C2 in FIG. 3) as its child candidate device (step S2142).

Next, the first child device (C1) may determine whether the selection of a parent candidate device and child candidate devices has been completed (step S2151) and may transmit information on the selected parent candidate device and child candidate devices to its parent device (L1) (step S2152).

For example, the first child device (C1) may determine that the selection process has been completed if classification of neighboring devices into parent candidate device and child candidate device has been completed based on the signals received from the neighboring devices (step S2151: YES).

As another example, the first child device (C1) may conclude the selection of the parent candidate device and child candidate devices to be completed if a predetermined amount of time has elapsed, or if a predetermined number of parent candidate devices and child candidate devices have been identified (step S2151: YES). The predetermined time and number may be preconfigured by a network administrator but are not limited thereto. As a non-limiting example, the predetermined time and number may be autonomously set by the first child device (C1) based on parameters such as the maximum network depth, the number of neighboring devices, the maximum number of child devices, and the maximum number of child routers.

If it is determined that the selection of the parent and child candidate devices is not complete (step S2151: NO), the first child device (C1) may continue to exchange signals with the neighboring devices and repeat the process of selecting parent and child candidate devices (steps S212 to S214).

As described above, by allowing the first router (L1) to cause its child devices to perform the process of determining candidate parent devices and candidate child devices through exchanging signals with neighboring devices (step S210), the first router (L1) can gradually collect role-switching devices across the entire network.

Referring again to FIG. 3, the first router (L1), which is disconnected from its parent device (step S221) (hereinafter referred to as an “orphaned router”), may perform a network self-healing process using the determined role-switching device (step S220).

The orphaned router (L1) may order the first child device (C1) to initiate a network rejoining process to the parent candidate device of the first child device as a child router (step S222). In response, the first child device (C1) may request its parent candidate device (P1) for network rejoining of the first child device (step S223). The first child device (C1) may be allocated a network address space for router role from its parent candidate device (P1) (step S224) and transmit the first router (i.e., the orphaned router) (L1) a signal indicating successful network rejoining as a router (step S225).

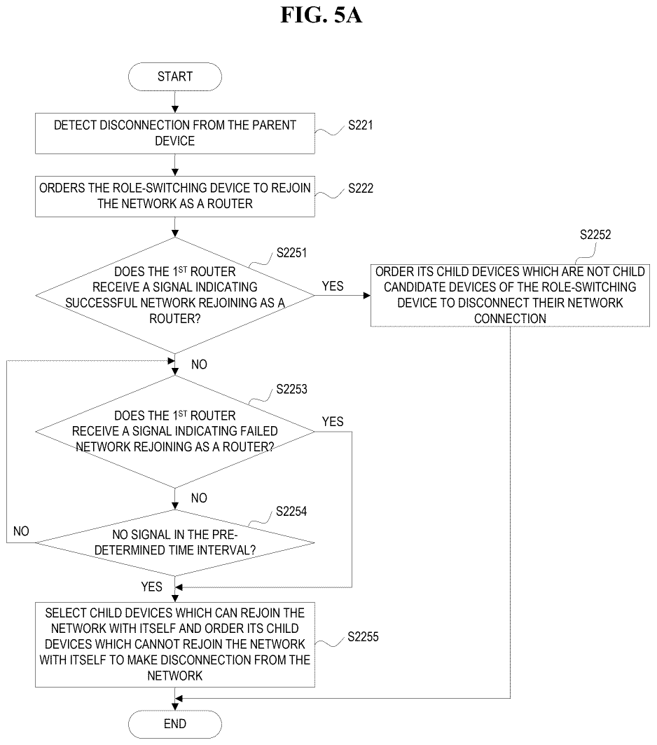

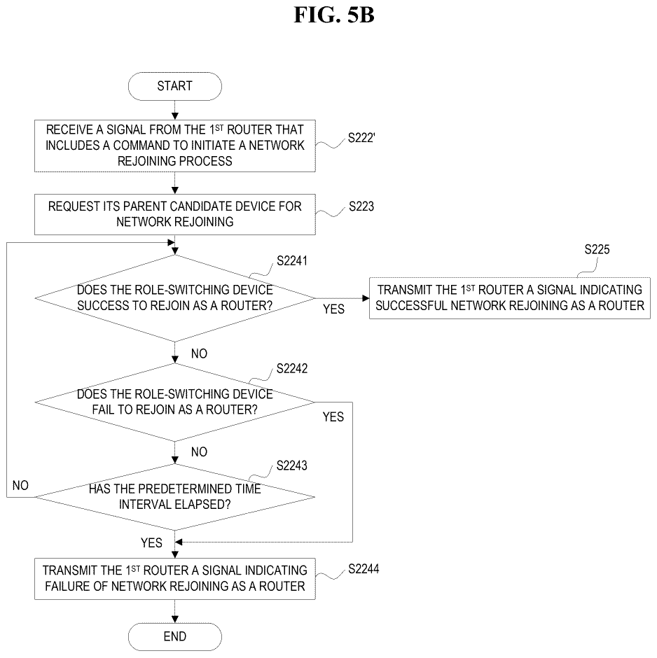

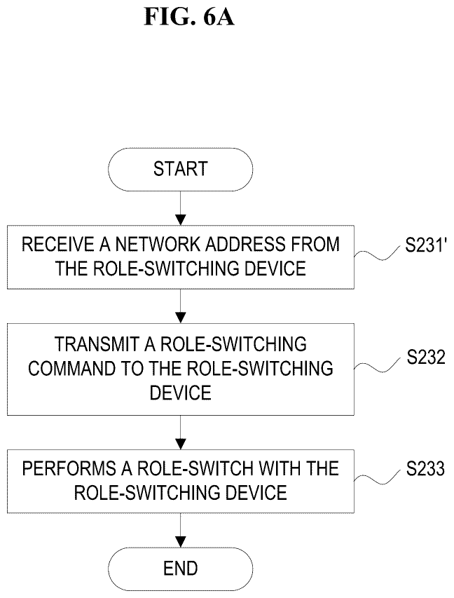

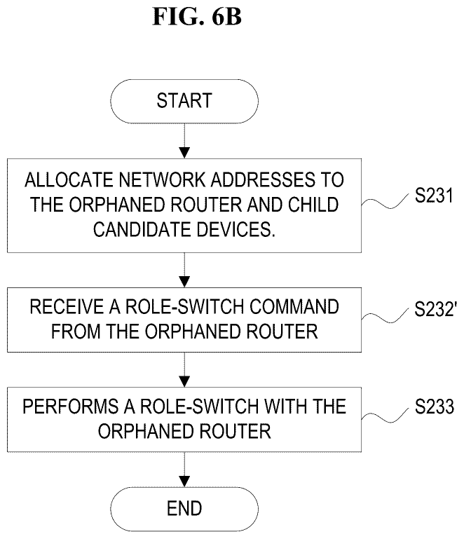

FIGS. 5A and 5B are flowcharts illustrating a network self-healing process using a role-switching device according to an embodiment of the present invention. Specifically, FIGS. 5A and 5B provide detailed descriptions of step S220 in FIG. 3 from the perspectives of the orphaned router (L1) and the first child device (C1), respectively.

Referring to FIG. 5A, when the first router (L1) is disconnected from its parent device (step S221), it may order the role-switching device to rejoin the network as a router (step S222). For example, the orphaned router (L1) may issue a command to the first child device (C1), serving as the role-switching device, to rejoin the network as a router, including network depth information sufficient to accommodate the child devices belonging to the orphan router's subtree.

Subsequently, if the orphaned router (L1) receives a signal indicating successful network rejoining of the role-switching device (C1) as a router (step S2251, YES), the orphaned router (L1) may determine that child devices not included in the set of child candidate devices of the role-switching device (C1) are unable to communicate with it, and may order those devices to disconnect their network connection (step S2252).

Meanwhile, when the orphan router (L1) does not receive a re-association failure signal from the role-switching device (C1) (S2253, NO), the orphan router (L1) may wait for a predetermined period of time to receive either a re-association success signal or a failure signal (S2554).

If the orphaned router (L1) receives a signal (step S2253, YES) informing failure of network rejoining of the role-switching device or it receives no signal in the predetermined time interval (step S2254, YES), the orphaned router (L1) may determine that the role-switching device (C1) has failed to rejoin the network as a router.

In such a case, the orphaned router (L1) may select child devices which can rejoin the network with itself together and orders its child devices which cannot rejoin the network with itself together to make disconnection from the network (step S2255).

In a specific example, assuming that the maximum depth of the network is denoted as Lₘₐₓ, and the network depth of a parent candidate device of the orphaned router (L1) is denoted as Lᵣₛᵥ, if the orphaned router (L1) has a parent candidate device with a network depth less than the maximum network depth minus one (i.e., Lᵣₛᵥ<Lₘₐₓ−1) and has child routers in the first tree structure, the orphaned router (L1) may order its child routers to individually rejoin the network by themselves and requests its parent candidate device for network rejoining with its child end devices.

Conversely, if the orphaned router (L1) has no parent candidate device with a network depth less than (Lₘₐₓ−1), the orphaned router (L1) may order all of its child devices to individually rejoin the network by themselves and requests its parent candidate device for network rejoining by itself alone.

Referring to FIG. 5B, upon receiving a signal from the orphaned router (L1) that includes a command to initiate a network rejoining process to the parent candidate device as a router (L1) (S222′), the role-switching device (C1) may request its parent candidate device (P1 in FIG. 3) for network rejoining (S223).

The parent candidate device (P1) receiving the network rejoin request from the role-switching device (C1) may allocate the role-switching device (C1) a network address space for router role. If no such address space is available, the parent candidate device (P1) may reject the network rejoin request of the role-switching device (C1).

If the role-switching device (C1) receives the network address allocation from the parent candidate device (P1), it may determine that it has successfully rejoined the network as a router (S2241, YES), and transmit the orphaned router (L1) a signal indicating successful network rejoining as a router (S225).

If the role-switching device (C1) does not receive the network address allocation from the parent candidate device (P1) and thus does not determine that it has successfully rejoined (S2241, NO), and further does not receive a rejection signal for the network rejoin from the parent candidate device (P1) (S2242, NO), the role-switching device (C1) may wait for a predetermined time interval to receive a signal indicating the success or failure of the network rejoin attempt (S2243).

If the role-switching device (C1) receives a network rejoin rejection signal from the parent candidate device (P1) (S2242, YES), or the predetermined time interval elapses without receiving a signal indicating successful network rejoining as a router (S2243, YES), the role-switching device (C1) may determine that the rejoin attempt has failed and may transmits the orphaned router (L1) a signal informing failure of network rejoining as a router (S2244).

Following step S225 and referring again to FIG. 3, after the role-switching device (C1) has successfully rejoined the network as a router via the parent candidate device (P1), it may update the network address of the orphaned router (L1) and the second child device (C2) and may perform a role-switching with the orphaned router (L1) (S230).

FIGS. 6A and 6B are flowcharts illustrating a process of updating network addresses and switching roles between an orphaned router and a role-switching device during a wireless network self-healing method according to an embodiment of the present invention. FIGS. 6A and 6B respectively describe the step of updating network addresses and switching roles (S230 in FIG. 3) from the perspectives of the first router (L1) and the first child device (C1).

Referring to FIG. 6A, the orphaned router (L1) may receive a network address space allocated by the role-switching device (C1), which has rejoined the network as a router in lieu of the orphaned router (S231′).

Subsequently, the orphaned router (L1), having received a network address space, may transmit the role-switching device (C1) a role-switching command that includes information on resources for communication with the child candidate device (C2) of the role-switching device (C1) that has rejoined as a router (S232).

Thereafter, the orphaned router (L1) may, after a predetermined time elapses, begin to function as a child device of the role-switching device (C1), which rejoined the network as a router (S233).

Referring to FIG. 6B, the role-switching device (C1), which has rejoined the network as a router in lieu of the orphaned router (L1), may assign network addresses to the orphaned router (L1) and a child candidate device (C2) using its available network address space (S231). Accordingly, a routing path based on the updated network addresses may be established even before the role-switch is completed.

Subsequently, the role-switching device (C1) may receive a role-switching command from the orphaned router (L1) (S232′). Based on the information included in the role-switching command, the role-switching device (C1) may operate as a parent device of the orphaned router (L1) and accept the child candidate device (C2) as its child device after successful communication with them using the information on resources for communication.

That is, after receiving the role-switching command from the orphaned router (L1), the role-switching device (C1) may, upon expiration of a predetermined time, begin to perform the role of the parent device of the orphaned router (L1), accept the child candidate device (C2) as its own child device, and communicate with the child candidate device using the same communication resources previously used by the orphaned router (L1) and the child candidate device (C2), thereby completing the role-switching process with the orphaned router (S233).

The respective features of various embodiments of the present invention may be partially or entirely combined or integrated with one another, may be technically linked or operated in various ways, and each embodiment may be implemented independently or in association with other embodiments.

While the invention has been described with reference to exemplary embodiments shown in the accompanying drawings, it will be understood by those of ordinary skill in the art that various modifications and changes may be made without departing from the spirit or essential characteristics of the present invention. The embodiments disclosed herein are intended to be illustrative rather than limiting in all respects. The scope of the invention should be defined not by the foregoing description but by the appended claims, and all equivalents falling within the scope of the claims are intended to be embraced therein. Furthermore, although specific terms have been used herein, they are used merely for the purpose of describing particular embodiments and are not intended to limit the scope of the invention as defined by the claims. Accordingly, the disclosed embodiments are exemplary in every respect and should not be construed as limiting.

1. A method for self-healing in a multi-hop cluster-tree structured wireless communication network, wherein the multi-hop cluster-tree structured network includes the 1^{st} router and the 1^{st} tree structure in which the 1^{st} router, operating as a cluster head, is connected to network devices in a parent-child device relationship, the method comprising;
a step in which the 1^{st} router selects a network device in the 1^{st} tree structure as a role-switching device;
a step in which the 1^{st} router performs a network self-healing process using the role-switching device; and
a step in which the 1^{st} router hands over its router role to the role-switching device;
wherein the role-switching device is a network device that can rejoin the network as a router in lieu of the 1^{st} router when the 1^{st} router is disconnected from its parent device.

2. The method of claim 1, further comprising;
a step in which the 1^{st} router selects a parent candidate device among cluster heads excluding routers in the sub-tree of its parent device;
wherein the step in which the 1^{st} router selects a network device in the 1^{st} tree structure as a role-switching device is performed in the absence of parent candidate devices that can allow network rejoining of the 1^{st} router and all of its child devices in the 1^{st} tree structure all together.

3. The method of claim 1, wherein the role-switching device is a network device in the 1^{st} tree structure and has a parent candidate device that can accept network rejoining of the 1^{st} router and all or some of child devices in the 1^{st} tree structure as child devices of the role-switching device when the 1^{st} router is disconnected from its parent device.

4. The method of claim 1, wherein the step in which the 1^{st} router selects a network device in the 1^{st} tree structure as a role-switching device comprises;
a step in which the 1^{st} router orders its child devices to select a device for its parent candidate and devices for its child candidate; and
a step in which the 1^{st} router gets information on the selected parent candidate device and child candidate devices from its child devices.

5. The method of claim 4, wherein the step in which the 1^{st} router selects a network device in the 1^{st} tree structure as a role-switching device comprises;
assuming that the maximum network depth is Lₘₐₓ, the network depth of the 1^{st} router is Lᵣₒᵤₜₑᵣ, where 0<Lᵣₒᵤₜₑᵣ<Lₘₐₓ, the network depth of the parent candidate device of a network device is L′ᵣₛᵥ, where 0≤L′ᵣₛᵥ<Lₘₐₓ, and the 1^{st} router has child routers,
a step in which the 1^{st} router selects a network device among its child devices as the role-switching device, which has a parent candidate device with a network depth less than that of the 1^{st} router (i.e., L′ᵣₛᵥ<Lᵣₒᵤₜₑᵣ) and has at least a predetermined number of child candidate devices.

6. The method of claim 5, wherein the step in which the 1^{st} router selects a network device in the 1^{st} tree structure as a role-switching device comprises;
when the 1^{st} router has no child router but has child end devices,
a step in which the 1^{st} router selects a network device as the role-switching device among its child devices, which has a parent candidate device with a network depth less than the maximum network depth minus one (i.e., L′ᵣₛᵥ<Lₘₐₓ−1) and has at least a predetermined number of child candidate devices.

7. The method of claim 1, wherein the step in which the 1^{st} router performs a network self-healing process using the role-switching device comprises;
a step in which the 1^{st} router orders the role-switching device to rejoin the network as a router by making network connection to the parent candidate device of the role-switching device; and
a step in which, when the 1^{st} router receives a signal indicating successful network rejoining of the role-switching device as a router, it orders its child devices which are not child candidate devices of the role-switching device to disconnect their network connection.

8. The method of claim 7, wherein the step in which the 1^{st} router performs a network self-healing process using the role-switching device comprises;
a step in which the 1^{st} router tries to receive a signal informing success or failure of network rejoining of the role-switching device as a router in a predetermined time interval; and
a step in which, if the 1^{st} router receives a signal informing failure of network rejoining of the role-switching device as a router or it receives no signal in the predetermined time interval, it selects child devices which can rejoin the network with itself together and orders its child devices which cannot rejoin the network with itself together to make disconnection from the network.

9-10. (canceled)

11. The method of claim 1, wherein the step in which the 1^{st} router hands over its router role to the role-switching device comprises;
a step in which the 1^{st} router receives a network address space allocated by the role-switching device;
a step in which the 1^{st} router transmits the role-switching device a role-switching command that includes information on resources for communication with the child candidate devices of the role-switching device; and
a step in which the 1^{st} router becomes as a child device of the role-switching device.

12. A method for self-healing in a multi-hop cluster-tree structured wireless communication network, wherein the multi-hop cluster-tree structured network includes the 1st router and the 1^{st} tree structure in which the 1^{st} router, operating as a cluster head, is connected to network devices in a parent-child device relationship, the method comprising;
a step in which the 1^{st} child device is selected as a role-switching device by the 1^{st} router;
a step in which the 1^{st} child device performs a network self-healing process by receiving a network address space from its parent candidate device; and
a step in which the 1^{st} child device allocates a network address space to the 1^{st} router and takes charge of a router role of the 1^{st} router;
wherein the 1^{st} child device is a network device that can rejoin the network as a router in lieu of the 1^{st} router when the 1^{st} router is disconnected from its parent device.

13. (canceled)

14. The method of claim 12, wherein the step in which the 1^{st} child device is selected as a role-switching device by the 1^{st} router comprises;
a step in which the 1^{st} child device receives a command from the 1^{st} router to select a device for its parent candidate and devices for its child candidates;
a step in which the 1^{st} child device selects the parent candidate device and the child candidate devices; and
a step in which the 1st child device transmits information on the selected parent candidate device and child candidate devices to the 1^{st} router.

15. The method of claim 14, wherein the step in which the 1^{st} child device selects the parent candidate device and the child candidate devices comprises;
a step in which the 1^{st} child device transmits and receives signals to and from its neighboring network devices in the network;
a step in which the 1^{st} child device determines whether the neighboring network devices are a cluster head in the 1^{st} tree structure based on the signals received from the neighboring network devices; and
a step in which the 1^{st} child device selects a cluster head which is not in the 1^{st} tree structure and can accept network rejoining of the 1^{st} child device as a router and has a link quality to and from the 1^{st} child device, equal to or greater than a predetermined value, as its parent candidate device.

16. The method of claim 14, wherein the step in which the 1^{st} child device selects the parent candidate device and the child candidate devices comprises;
a step in which the 1^{st} child device transmits and receives signals to and from its neighboring network devices in the network;
a step in which the 1^{st} child device determines whether the neighboring network devices are a sibling device of the 1^{st} child device based on the signals received from the neighboring network devices; and
a step in which the 1^{st} child device selects a cluster head which is a child device of the 1^{st} router and has a link quality to and from the 1^{st} child device equal to or greater than a predetermined value, as its child candidate device.

17. The method of claim 14, wherein the step in which the 1^{st} child device is selected as a role-switching device by the 1^{st} router further comprises;
assuming that the maximum network depth is Lₘₐₓ, the network depth of the 1^{st} router is Lᵣₒᵤₜₑᵣ, where 0<Lᵣₒᵤₜₑᵣ<Lₘₐₓ, the network depth of the parent candidate device of the 1^{st} child device is L′ᵣₛᵥ, where 0≤L′ᵣₛᵥ<Lₘₐₓ, and the 1^{st} router has child routers, a step in which the 1^{st} child device is selected as a role-switching device by the 1^{st} router if it has a parent candidate device with a network depth less than that of the 1^{st} router (i.e., L′ᵣₛᵥ<Lᵣₒᵤₜₑᵣ) and has at least a predetermined number of child candidate devices.

18. The method of claim 17, wherein the step in which the 1^{st} child device is selected as a role-switching device by the 1^{st} router further comprises;
a step in which, the 1^{st} child device is selected as the role-switching device by the 1^{st} router provided that the 1^{st} router does not have any child router but has at least one child end device, the 1^{st} child device has a parent candidate device with a network depth less than the maximum network depth minus one (i.e., L′ᵣₛᵥ<Lₘₐₓ−1) and has at least a predetermined number of child candidate devices.

19. The method of claim 12, wherein the step in which the 1^{st} child device performs a network self-healing process comprises;
a step in which the 1^{st} child device receives a signal from the 1^{st} router, that includes a command to initiate a network rejoining process to the parent candidate device of the 1^{st} child device as a child router;
a step in which the 1^{st} child device requests its parent candidate device for network rejoining of the 1^{st} child device; and
a step in which the 1^{st} child device transmits the 1^{st} router a signal informing success or failure of network rejoining as a router.

20. (canceled)

21. The method of claim 12, wherein the step in which the 1^{st} child device allocates a network address space to the 1^{st} router and takes charge of a router role of the 1^{st} router comprises;
a step in which the 1^{st} child device allocates a network address space to the 1^{st} router and its child candidate devices, which is a portion of the network address space allocated by its parent candidate device;
a step in which the 1^{st} child device receives a role-switching command from the 1^{st} router, which includes information on resources for communication with the child candidate devices of the 1^{st} child device; and
a step in which the 1^{st} child device takes charge of a router role of the 1^{st} router.

22. The method of claim 21, wherein the step in which the 1^{st} child device takes charge of a router role of the 1^{st} router comprises;
a step in which the 1^{st} child device operates as a parent device of the 1^{st} router and accepts the child candidate devices as its child devices after successful communication with them using the information on resources for communication.

23. A non-transitory computer-readable recording medium storing a program for executing the method according to claim 1.

24. A non-transitory computer-readable recording medium storing a program for executing the method according to claim 12.
